(19) United States
(12) Patent Application Publication
(10) Pub. No.: US 2026/0034857 A1
(43) Pub. Date: Feb. 5, 2026

(54) COOLING SYSTEM

(71) Applicant: MAZDA MOTOR CORPORATION, Hiroshima (JP)

(72) Inventors: Kentaro KAWAGUCHI, Hiroshima (JP); Yuma MIYAUCHI, Hiroshima (JP)

(73) Assignee: MAZDA MOTOR CORPORATION, Hiroshima (JP)

(21) Appl. No.: 19/273,166

(22) Filed: Jul. 18, 2025

(30) Foreign Application Priority Data
Jul. 31, 2024 (JP) 2024-124220

(51) Int. Cl. B60H 1/00; B60H 1/32; B60L 58/26; F25B 9/00

(52) U.S. Cl. CPC B60H 1/00899; B60H 1/00278; B60H 1/32284; B60L 58/26; F25B 9/008; B60H 2001/00949; B60H 2001/3251; B60H 2001/3261

(57) ABSTRACT

A cooling system includes a compressor that compresses a refrigerant, a heat exchanger that cools the refrigerant from the compressor, heat exchangers that use the refrigerant cooled by the heat exchanger, a refrigerant passage that supplies the refrigerant from the heat exchangers to a battery, a refrigerant passage that supplies the refrigerant cooled by the heat exchanger to the refrigerant passage without passing the refrigerant through the heat exchangers an expansion valve provided on the refrigerant passage, and a flow control valve provided on the refrigerant passage, and a processing circuitry increases the opening degree of the flow control valve when the specific enthalpy of the refrigerant supplied to the battery exceeds a predetermine range and reduces the opening degree of the flow control valve when the specific enthalpy is below the predetermined range.

### CROSS-REFERENCE TO RELATED APPLICATION

This application claims priority under 35 U.S.C. § 119(a) to Application No. 2024-124220, filed in Japan on Jul. 31, 2024, the entire contents of which is hereby incorporated by reference into the present application.

### TECHNICAL FIELD

One or more embodiments of the present disclosure relate to a cooling system that performs cooling inside a vehicle by circulating a refrigerant containing CO₂.

A system that circulates a refrigerant through a compressor and a heat exchanger has been conventionally used in a refrigeration cycle used in an air conditioner. In addition, in recent years, such a system that circulates a refrigerant has also been used to cool a component inside a vehicle, for example, to cool a battery of an electric vehicle or a hybrid vehicle. In one example, Patent Literature 1 describes a system that cools and heats a battery cell by connecting a compressor, a first heat exchanger, and a second heat exchanger through a refrigerant channel and performing heat exchange between a refrigerant and the battery cell using the second heat exchanger.

### SUMMARY OF THE DISCLOSURE

In recent years, there has been a growing requirement for cooling batteries due to quicker charging and higher power output of batteries, and a battery cooling technique using, for example, a cooling water that has insulating properties and can directly cool the inside of a battery has been developed. In such a battery cooling technique using a coolant or the like, while high cooling capability can be expected, pressure loss caused by the viscosity of oil occurs. In response to this, the present inventors considered using a refrigerant containing CO₂, the refrigerant having insulating properties and low viscosity (hereinbelow, referred to as the “CO₂ refrigerant” as appropriate), to efficiently cool a battery while reducing pressure loss. Since such a CO₂ refrigerant is a so-called natural refrigerant, influences on environment and the human body are also taken into consideration.

Here, when the battery is cooled using the CO₂ refrigerant, typically, the CO₂ refrigerant that has been brought to high pressure by a compressor may be decompressed by an expansion valve and supplied to the battery. This is because it is not desirable to supply the high-pressure CO₂ refrigerant as it is to the battery in some cases. For example, it is not desirable to supply the high-pressure CO₂ refrigerant to a plurality of cells inside the battery.

However, when the CO₂ refrigerant to be supplied to the battery is decompressed by the expansion valve as described above, there is a possibility that the CO₂ refrigerant changes to a dry ice state due to the decompression when the CO₂ refrigerant is in a relatively low enthalpy state. Since such a CO₂ refrigerant in a dry ice state cannot uniformly cool the battery due to its low fluidity and causes the occurrence of a local low-temperature area due to its extremely low temperature, which causes degradation in the performance of the battery or deterioration of the battery.

Thus, the CO₂ refrigerant to be supplied to the battery may be heated by heat exchange to bring the CO₂ refrigerant into a relatively high enthalpy state before decompression. This can prevent the CO₂ refrigerant from changing to a dry ice state when the CO₂ refrigerant is decompressed. However, if the enthalpy of the CO₂ refrigerant is made too high, the temperature of the CO₂ refrigerant becomes high (specifically, the temperature of the CO₂ refrigerant becomes close to the temperature of the battery), and the cooling capability for the battery using the CO₂ refrigerant cannot be obtained.

The one or more embodiments have been made to solve the problems in the conventional technique described above, and an object thereof is, in a cooling system that performs cooling inside a vehicle by circulating a refrigerant containing CO₂, to properly and efficiently cool a battery using the refrigerant.

### Means for Solving the Problems

In order to achieve the above-mentioned object, the one or more embodiments include a cooling system that performs cooling inside a vehicle by circulating a refrigerant containing CO₂, the cooling system including: a compressor that compresses the refrigerant; a first heat exchanger for cooling the refrigerant compressed by the compressor; a second heat exchanger for cooling a predetermined cooling target inside the vehicle using the refrigerant cooled by the first heat exchanger; a first refrigerant passage for supplying the refrigerant that has been used for cooling in the second heat exchanger to a battery inside the vehicle to further cool the battery using the refrigerant; a second refrigerant passage for supplying the refrigerant cooled by the first heat exchanger to the first refrigerant passage without passing the refrigerant through the second heat exchanger; an expansion valve for expanding the refrigerant, the expansion valve being provided on the first refrigerant passage; a flow control valve for adjusting a flow rate of the refrigerant, the flow control valve being provided on the second refrigerant passage; and a control device configured to control at least the flow control valve, characterized in that the control device is configured to obtain an enthalpy of the refrigerant supplied from the first refrigerant passage to the battery, and perform control to increase an opening degree of the flow control valve when the enthalpy exceeds a predetermine range and perform control to reduce the opening degree of the flow control valve when the enthalpy is below the predetermined range.

According to the one or more embodiments configured in this manner, since the refrigerant in a relatively low enthalpy state from the first heat exchanger is brought into a relatively high enthalpy state by heat exchange in the second heat exchanger, and this refrigerant is supplied to the battery, it is possible to restrain the refrigerant in a dry ice state from being supplied to the battery. That is, it is possible to restrain the refrigerant supplied to the battery from becoming a dry ice state due to the expansion (e.g., decompression) of the expansion valve provided on the first refrigerant passage. In addition, in the one or more embodiments, not only the refrigerant in a relatively high enthalpy state from the second heat exchanger, but also the refrigerant in a relatively low enthalpy state from the first heat exchanger that has not passed through the second heat exchanger is supplied to the battery. In particular, in the one or more embodiments, by adjusting the amount of the refrigerant in a relatively low enthalpy state from the first heat exchanger that is to be mixed with the refrigerant in a relatively high enthalpy state from the second heat exchanger by controlling the opening degree of the flow control valve on the second refrigerant passage, the enthalpy of the refrigerant supplied to the battery is maintained within the predetermined range. Accordingly, it is possible to supply the refrigerant having a relatively low temperature to the battery and effectively cool the battery using the refrigerant. From above, according to the one or more embodiments, it is possible to improve the cooling capability for the battery using refrigerant while restraining the refrigerant in a dry ice state from being supplied to the battery.

In the one or more embodiments, preferably, the cooling system further includes a battery heat exchanger for directly cooling a plurality of cells inside the battery using the refrigerant by passing the refrigerant from the first refrigerant passage around the plurality of cells, and the battery heat exchanger is supplied with the refrigerant decompressed by the expansion valve.

According to the one or more embodiments configured in this manner, since the plurality of cells are directly cooled using the refrigerant in the battery heat exchanger, it is possible to effectively cool the plurality of cells. In this case, since it is not desirable to supply the high-pressure refrigerant from the compressor as it is to the battery heat exchanger because the pressure resistance of a battery pack and the like is relatively low, the refrigerant from the compressor is decompressed by the expansion valve and supplied to the battery heat exchanger in the one or more embodiments. Accordingly, it is possible to properly protect the inside of the battery (such as the plurality of cells).

In the one or more embodiments, preferably, the cooling system further includes, when the flow control valve is defined as a first flow control valve, a second flow control valve for adjusting a flow rate of the refrigerant supplied to the second heat exchanger, and the control device is configured to perform control to increase an opening degree of the second flow control valve when the enthalpy exceeds the predetermined range and the first flow control valve is fully open, and perform control to reduce the opening degree of the second flow control valve when the enthalpy is below the predetermined range and the first flow control valve is fully closed.

According to the one or more embodiments configured in this manner, when the first flow control valve is already in a fully open state, since the refrigerant flow rate is insufficient for the cooling requirements in the cooling system, it is possible to increase the refrigerant flow rate by increasing the opening degree of the second flow control valve, and, on the other hand, when the first flow control valve is already in a fully closed state, since the refrigerant flow rate is excessive for the cooling requirements in the cooling system, it is possible to reduce the refrigerant flow rate by reducing the opening degree of the second flow control valve.

In the one or more embodiments, preferably, the predetermined range is set to a range higher than an enthalpy at which the refrigerant containing CO₂ becomes a dry ice state.

According to the one or more embodiments configured in this manner, it is possible to reliably restrain the refrigerant in a dry ice state from being supplied to the battery.

In the one or more embodiments, preferably, the predetermined range is set on the basis of an enthalpy at which a superheat degree defined by a saturated vapor line in the refrigerant is less than a predetermined value.

According to the one or more embodiments configured in this manner, it is possible to supply the refrigerant having a relatively small superheat degree (that is, the refrigerant having a relatively low temperature that is not in a dry ice state) to the battery and effectively improve the cooling capability for the battery using refrigerant.

In the one or more embodiments, preferably, the cooling system further includes a refrigerant pressure sensor that detects a pressure of the refrigerant from the first heat exchanger, and a refrigerant temperature sensor that detects a temperature of the refrigerant inside the first refrigerant passage, and the control device obtains the enthalpy from the pressure and the temperature respectively detected by the refrigerant pressure sensor and the refrigerant temperature sensor.

According to the one or more embodiments configured in this manner, by using the pressure and the temperature of the refrigerant detected by the sensors, it is possible to accurately obtain the enthalpy of the refrigerant.

In the one or more embodiments, preferably, the second heat exchanger includes an air conditioning heat exchanger for performing air conditioning of the vehicle and/or a battery heat exchanger for indirectly cooling a plurality of cells using the refrigerant by supplying the refrigerant to outside of a battery pack including the plurality of cells in the battery.

According to the one or more embodiments configured in this manner, one system (e.g., cooling system) that circulates the refrigerant can appropriately achieve air conditioning of the vehicle and cooling of the battery. In particular, by using the battery heat exchanger that supplies the refrigerant to the outside of the battery pack, it is possible to appropriately cool the battery and achieve relatively large heat exchange with the refrigerant.

In the one or more embodiments, preferably, the first heat exchanger is configured as a cascade heat exchanger that performs heat exchange between a first heat cycle circuit including at least the compressor, the second heat exchanger, the first and second refrigerant passages, the expansion valve, and the flow control valve and a second heat cycle circuit including an outside air heat exchanger that exchanges heat with outside air separately from the first heat cycle circuit.

According to the one or more embodiments configured in this manner, by causing the first heat cycle circuit to perform heat exchange (e.g., cascade heat exchange) with the second heat cycle circuit that exchanges heat with the outside air, it is possible to improve the efficiency of the entire system of the first heat cycle circuit, in other words, reduce the work of the compressor inside the first heat cycle circuit.

In the one or more embodiments, preferably, the cooling system is configured to further cool, using the refrigerant cooled by the first heat exchanger, a motor that drives the vehicle using electric power of the battery.

According to the one or more embodiments configured in this manner, one system (e.g., cooling system) that circulates the refrigerant can appropriately achieve cooling of various components inside the vehicle, such as the motor.

### Advantageous Effects of Invention

According to the one or more embodiments, in a cooling system that performs cooling inside a vehicle by circulating a refrigerant containing CO₂, it is possible to properly and efficiently cool a battery using the refrigerant.

### BRIEF DESCRIPTION OF DRAWINGS

FIG. 1 is a schematic configuration diagram of a vehicle to which a cooling system according to the one or more embodiments is applied.

FIG. 2 is a schematic configuration diagram of the cooling system according to the one or more embodiments.
(a) of FIG. 3 and (b) of FIG. 3 are schematic configuration diagrams of a first battery heat exchanger and a second battery heat exchanger according to the one or more embodiments, respectively.

FIG. 4 is a block diagram showing an electrical configuration of the cooling system according to the one or more embodiments.

FIG. 5 is an explanatory diagram regarding a basic concept of control according to the one or more embodiments.

FIG. 6 is a flowchart showing the control according to the one or more embodiments.

Hereinbelow, a cooling system according to an embodiment of the one or more embodiments will be described with reference to the accompanying drawings.

### ENTIRE CONFIGURATION

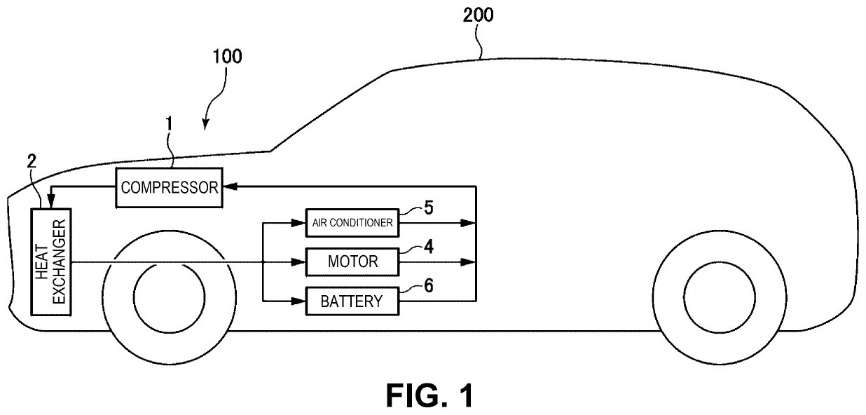

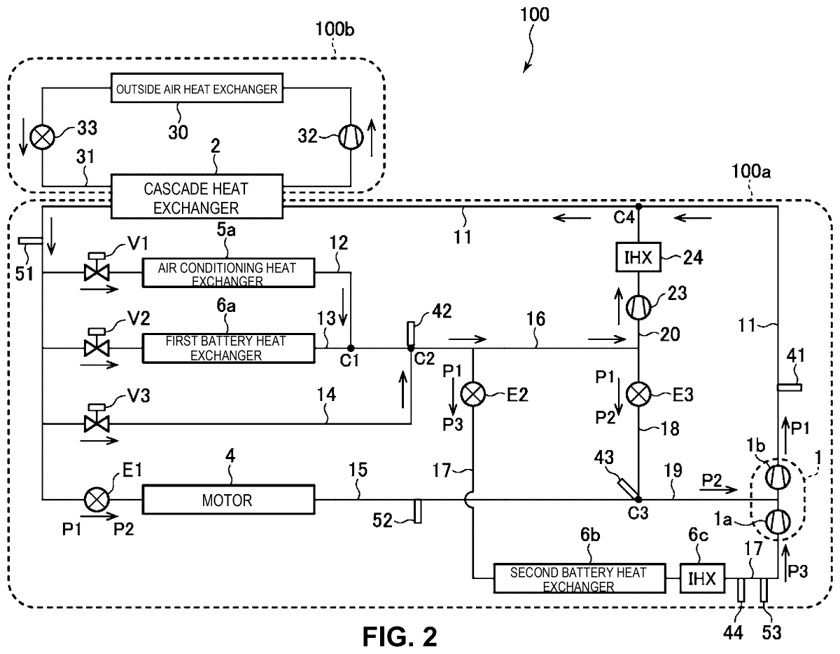

First, the entire configuration of the cooling system according to the one or more embodiments will be described with reference to FIG. 1. FIG. 1 is a schematic configuration diagram of a vehicle to which the cooling system according to the one or more embodiments is applied.

As shown in FIG. 1, a vehicle 200 is, for example, an electric vehicle, and includes a cooling system 100 that circulates a refrigerant in a refrigeration cycle. The cooling system 100 mainly includes a compressor 1 for compressing the refrigerant, a heat exchanger 2 for cooling the refrigerant compressed by the compressor 1, a motor (e.g., electric motor) 4 for generating power to drive the vehicle 200, an air conditioner 5 that performs air conditioning inside the vehicle 200, and a battery 6 that supplies electric power to drive the motor 4.

The cooling system 100 circulates a CO₂ refrigerant (hereinbelow, may be simply referred to as the “refrigerant”) as a natural refrigerant. Typically, the CO₂ refrigerant is a refrigerant containing CO₂, a refrigerating machine oil (e.g., oil), such as Polyalkylene Glycol (PAG), and an additive. Since such a CO₂ refrigerant is used, the compressor 1 is configured to compress the refrigerant to an extremely high pressure. The motor 4 uses the refrigerant (e.g., in a liquid state (typically, in a supercritical state)) compressed by the compressor 1 in this manner for cooling of a rotor and a stator. In addition, the motor 4 is configured to also use the refrigerant for lubrication of a sliding bearing that supports a rotation shaft. In addition, the refrigerant compressed by the compressor 1 is used for air conditioning in the air conditioner 5 and cooling of the battery 6. For example, in the cooling system 100, the high-temperature and high-pressure gas refrigerant is supplied from the compressor 1 to the heat exchanger 2, the low-temperature and high-pressure liquid refrigerant is supplied from the heat exchanger 2 to the motor 4 and the like, and the normal-temperature and low-pressure gas refrigerant is supplied from the motor 4 and the like to the compressor 1.

### Configuration of Cooling System

Next, the cooling system 100 according to the one or more embodiments will be specifically described with reference to FIG. 2. FIG. 2 is a schematic configuration diagram of the cooling system 100 according to the one or more embodiments.

As shown in FIG. 2, the cooling system 100 includes a first heat cycle circuit (e.g., low-temperature circuit) 100a that circulates the above-mentioned CO₂ refrigerant, and a second heat cycle circuit (e.g., high-temperature circuit) 100b that includes an outside air heat exchanger 30 that exchanges heat with outside air and circulates a refrigerant such as propane or a fluorine-based refrigerant, and is configured to achieve a cascade refrigeration cycle. Specifically, the first heat cycle circuit 100a and the second heat cycle circuit 100b perform cascade heat exchange in the heat exchanger 2 (hereinbelow, the heat exchanger 2 is referred to as the “cascade heat exchanger 2” as appropriate). The cascade heat exchanger 2 corresponds to the “first heat exchanger” in the one or more embodiments.

The first heat cycle circuit 100a of the cooling system 100 mainly includes, in addition to the compressor 1 and the motor 4 described above, an air conditioning heat exchanger 5a for performing heat exchange in the air conditioner 5 (e.g., specifically, an evaporator that generates cold air to be supplied to the inside of the vehicle), a first battery heat exchanger 6a and a second battery heat exchanger 6b that perform heat exchange to cool the battery 6, refrigerant passages 11 to 20 through which the refrigerant flows, a pressure feeder 23 that pressure-feeds the refrigerant, flow control valves V1, V2, V3 that adjust the flow rate of the refrigerant, and expansion valves E1, E2, E3 that expand and decompress the refrigerant.

In the one or more embodiments, the compressor 1 includes a first compressor 1a on the upstream side and a second compressor 1b on the downstream side, and is configured to compress the refrigerant in two stages. The first compressor 1a increases a pressure P3 of the refrigerant to a pressure P2 (e.g., the pressure P2>the pressure P3), and the second compressor 1b increases the pressure P2 of the refrigerant to a pressure P1 (e.g., the pressure P1>the pressure P2). In one example, the pressure P1 is approximately 3 MPa, the pressure P2 is approximately 1.5 MPa, and the pressure P3 is approximately 0.1 MPa.

In addition, in the one or more embodiments, the battery 6 is configured to be cooled by two heat exchangers, that is, the first battery heat exchanger 6a and the second battery heat exchanger 6b. The configuration of the first battery heat exchanger 6a and the second battery heat exchanger 6b will be described with reference to (a) of FIG. 3 and (b) of FIG. 3. (a) of FIG. 3 and (b) of FIG. 3 schematically show examples of the first battery heat exchanger 6a and the second battery heat exchangers 6b, respectively. More specifically, (a) of FIG. 3 is a plan view of a battery pack 61 of the battery 6 viewed from the outside, and (b) of FIG. 3 is a plan perspective view of the inside of the battery pack 61.

As shown in (a) of FIG. 3, the first battery heat exchanger 6a is configured to indirectly cool a plurality of cells 62 inside the battery 6 using the refrigerant by supplying the refrigerant to the outside of the battery pack 61 (typically, the surface of a case) including the plurality of cells 62 in the battery 6, more specifically, by passing the refrigerant through a channel 63 that is formed in a meandering manner. Note that the configuration that indirectly cools the cells 62 inside the battery 6 using the refrigerant is not limited to the configuration shown in (a) of FIG. 3, and various known configurations can be adopted. On the other hand, as shown in (b) of FIG. 3, the second battery heat exchanger 6b is configured to directly cool the plurality of cells 62 using the refrigerant by passing the refrigerant around the plurality of cells 62 inside the battery 6, that is, by passing the refrigerant inside the battery pack 61. Note that the first battery heat exchanger 6a and the air conditioning heat exchanger 5a described above correspond to the “second heat exchanger” in the one or more embodiments. In this case, the air conditioning heat exchanger 5a cools the evaporator (e.g., cooling target) of the air conditioner 5 using the refrigerant, and the first battery heat exchanger 6a cools the battery 6 (e.g., cooling target) using the refrigerant.

Referring back to FIG. 2, the flow of the refrigerant inside the first heat cycle circuit 100a will be specifically described. The refrigerant compressed by the compressor 1 is supplied from the refrigerant passage 11 to the cascade heat exchanger 2, and the refrigerant cooled by the cascade heat exchanger 2 is supplied from the refrigerant passages 12, 13, 15 connected to the refrigerant passage 11 to the air conditioning heat exchanger 5a, the first battery heat exchanger 6a, and the motor 4, respectively. The refrigerant passage 12 and the refrigerant passage 13 join at a confluence C1 and are connected to the refrigerant passage 16, which causes the refrigerant that has exchanged heat in the air conditioning heat exchanger 5a and the refrigerant that has exchanged heat in the first battery heat exchanger 6a to be supplied to the refrigerant passage 16. In addition, the refrigerant cooled by the cascade heat exchanger 2 is directly supplied to the refrigerant passage 16 through the refrigerant passage 14 that is connected to the refrigerant passage 11, without passing through the air conditioning heat exchanger 5a and the first battery heat exchanger 6a (that is, bypassing the refrigerant passages 12, 13, 15). In this case, the refrigerant passage 14 and the refrigerant passage 16 join at a confluence C2 that is downstream of the confluence C1 described above. In addition, the refrigerant passages 12, 13, 14 are respectively provided with the flow control valves V1, V2, V3 for adjusting the flow rate of the refrigerant flowing through each passage, and the refrigerant passage 15 is provided with the expansion valve E1 for expanding the refrigerant to be supplied to the motor 4. The expansion valve E1 functions to decompress the refrigerant from the pressure P1 to the pressure P2. Note that the flow control valve V3 corresponds to the “first flow control valve” in the one or more embodiments, and the flow control valves V1, V2 correspond to the “second flow control valve” in the one or more embodiments.

In addition, the refrigerant passage 17 is connected to the refrigerant passage 16 so that the refrigerant inside the refrigerant passage 16 is supplied from the refrigerant passage 17 to the second battery heat exchanger 6b. In the refrigerant passage 17, the expansion valve E2 for expanding the refrigerant is provided upstream of the second battery heat exchanger 6b, which causes the refrigerant decompressed by the expansion valve E2 to be supplied to the second battery heat exchanger 6b. The expansion valve E2 functions to decompress the refrigerant from the pressure P1 to the pressure P3. In addition, in the refrigerant passage 17, an internal heat exchanger (IHX) 6c having a known double-tube structure is provided downstream of the second battery heat exchanger 6b, and the downstream side thereof is further connected to the first compressor 1a of the compressor 1. The refrigerant having the pressure P3 decompressed by the above-mentioned expansion valve E2 is supplied to the first compressor 1a. Note that the refrigerant passage 17 corresponds to the “first refrigerant passage” in the one or more embodiments, and the refrigerant passage 14 corresponds to the “second refrigerant passage” in the one or more embodiments.

Furthermore, the refrigerant passage 16 branches into the refrigerant passage 18 and the refrigerant passage 20 at a position downstream of a connection point with the refrigerant passage 17. The refrigerant passage 18 is provided with the expansion valve E3 for expanding the refrigerant. The expansion valve E3 functions to decompress the refrigerant from the pressure P1 to the pressure P2. In addition, at a confluence C3 that is downstream of the expansion valve E3, the refrigerant passage 18 joins the refrigerant passage 15 that is provided with the motor 4 described above, and the refrigerant passages 15, 18 are connected to the refrigerant passage 19. The refrigerant passage 19 is connected between the first compressor 1a and the second compressor 1b of the compressor 1, and supplies the refrigerant having the pressure P2 decompressed by the expansion valve E1 and the expansion valve E3 to the second compressor 1b. On the other hand, the refrigerant passage 20 is connected, at a confluence C4 on its downstream side, to the refrigerant passage 11 between the compressor 1 and the cascade heat exchanger 2. The refrigerant passage 20 is provided with the pressure feeder 23 and an internal heat exchanger (IHX) 24 having a known double-tube structure. Such a refrigerant passage 20 enables the pressure feeder 23 to supply the refrigerant from the above-mentioned refrigerant passage 16 to the cascade heat exchanger 2, without passing the refrigerant through the compressor 1 (that is, bypassing the compressor 1).

Next, the second heat cycle circuit 100b of the cooling system 100 is a high-temperature circuit that circulates the refrigerant such as propane or a fluorine-based refrigerant as described above, and includes, in addition to the outside air heat exchanger 30 that exchanges heat with the outside air, a refrigerant passage 31 through which the refrigerant flows, a pressure feeder 32 that pressure-feeds the refrigerant, and an expansion valve 33 that expands the refrigerant. In the cooling system 100 according to the one or more embodiments, providing such a second heat cycle circuit 100b separately from the first heat cycle circuit 100a improves the efficiency of the entire system of the first heat cycle circuit 100a, in other words, reduces the work of the compressor 1.

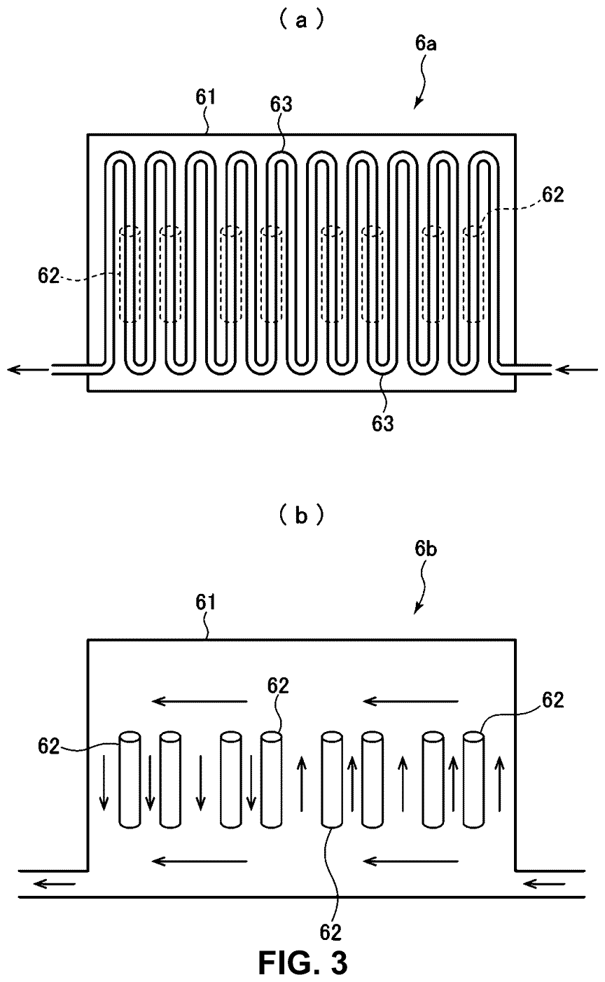

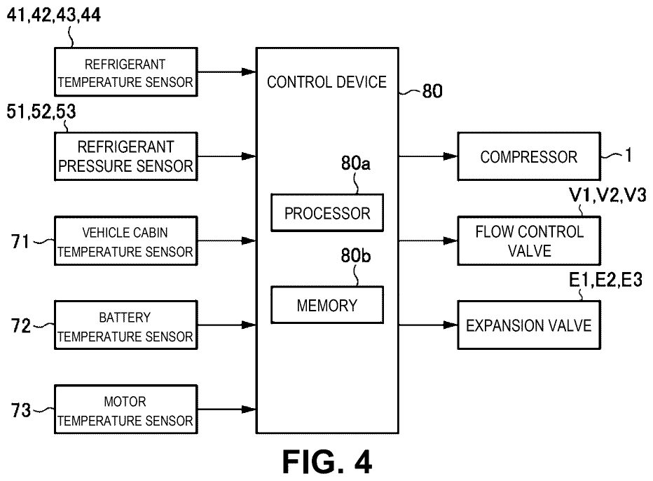

Next, the electrical configuration of the cooling system 100 according to the one or more embodiments will be described with reference to FIG. 4 in addition to FIG. 2. FIG. 4 is a block diagram showing the electrical configuration of the cooling system 100 according to the one or more embodiments.

As shown in FIG. 4, the cooling system 100 includes a control device 80 that is configured to perform various types of control in the system. The control device 80 is composed of a computer including one or more processors 80a (typically, CPUs), and a memory 80b such as a ROM or a RAM that stores various programs (including a basic control program such as an OS and an application program that is started on the OS to implement a specific function) that are interpreted and executed on the processor 80a, and various data. The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

In addition, the cooling system 100 includes refrigerant temperature sensors 41, 42, 43, 44 that detect the temperature of the refrigerant and refrigerant pressure sensors 51, 52, 53 that detect the pressure of the refrigerant, the refrigerant temperature sensors 41, 42, 43, 44 and the refrigerant pressure sensors 51, 52, 53 being provided in the first heat cycle circuit 100a (refer to FIG. 2), a vehicle cabin temperature sensor 71 that detects the temperature of a vehicle cabin (cabin), a battery temperature sensor 72 that detects the temperature of the battery 6, and a motor temperature sensor 73 that detects the temperature of the motor 4. Specifically, as shown in FIG. 2, the refrigerant temperature sensor 41 is provided on the refrigerant passage 11 between the compressor 1 and the cascade heat exchanger 2 (specifically, upstream of the confluence C4 of the refrigerant passage 11 and the refrigerant passage 20), the refrigerant temperature sensor 42 is provided at the confluence C2 of the refrigerant passage 14 and the refrigerant passage 16, the refrigerant temperature sensor 43 is provided at the confluence C3 of the refrigerant passage 15 and the refrigerant passage 18, and the refrigerant temperature sensor 44 is provided on the refrigerant passage 17 downstream of the second battery heat exchanger 6b and the IHX 6c. In addition, the refrigerant pressure sensor 51 is provided on the refrigerant passage 11 downstream of the cascade heat exchanger 2, the refrigerant pressure sensor 52 is provided on the refrigerant passage 15 downstream of the motor 4, and the refrigerant pressure sensor 53 is provided on the refrigerant passage 17 downstream of the second battery heat exchanger 6b and the IHX 6c.

The control device 80 supplies control signals to the compressor 1, the flow control valves V1, V2, V3, and the expansion valves E1, E2, E3 on the basis of detection signals from the above-mentioned sensors 41 to 44, 51 to 53, 71 to 73, thereby controlling these. In particular, in the one or more embodiments, the control device 80 controls the opening degrees of the flow control valves V1, V2, V3 and the discharge amount of the compressor 1, so as to properly and efficiently cool the battery 6 using the refrigerant in the second battery heat exchanger 6b (details will be described further below).

### Control Method

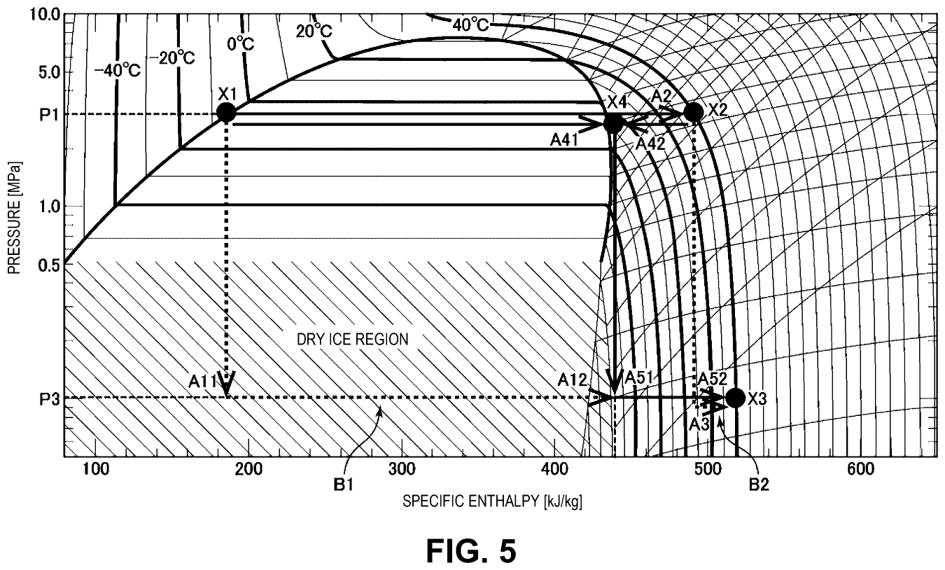

Next, control performed by the control device 80 in the one or more embodiments will be described. First, a basic concept of the control according to the one or more embodiments will be described with reference to FIG. 5. FIG. 5 shows the specific enthalpy (the enthalpy per unit mass) of the CO₂ refrigerant on the horizontal axis and shows the pressure of the CO₂ refrigerant on the vertical axis. Specifically, FIG. 5 shows a part of the Mollier diagram (p-h diagram) obtained by the first heat cycle circuit 100a of the cooling system 100. Note that the specific enthalpy illustrated in FIG. 5 is defined relative to a point on the liquid side of the saturated vapor pressure line at 0° C. (200 KJ/kg).

As described above, in the one or more embodiments, in the second battery heat exchanger 6b, the refrigerant is passed around the plurality of cells 62 inside the battery pack 61 to directly cool the plurality of cells 62 using the refrigerant ((b) of FIG. 3), but, in this case, it is not desirable to supply the refrigerant that has been brought to high pressure by being compressed by the compressor 1 as it is to the second battery heat exchanger 6b because the pressure resistance of the battery pack 61 is relatively low. Thus, in the one or more embodiments, the refrigerant that has been brought to high pressure by being compressed by the compressor 1 is decompressed (e.g., from the pressure P1 to the pressure P3) by the expansion valve E2 that is provided upstream of the second battery heat exchanger 6b in the refrigerant passage 17 and supplied to the second battery heat exchanger 6b (FIG. 2).

However, as shown in FIG. 5, when the refrigerant in a relatively low enthalpy state (point X1) that has been cooled in the cascade heat exchanger 2 is decompressed as it is (arrow A11) and supplied to the second battery heat exchanger 6b (arrow A12), the refrigerant (CO₂ refrigerant) becomes a dry ice state. For example, the refrigerant becomes a dry ice state at a specific enthalpy of 440 KJ/kg or less. Since the refrigerant in a dry ice state cannot uniformly cool gaps between the cells 62 inside the battery 6 due to its low fluidity and causes the occurrence of a local low-temperature area due to its extremely low temperature, which causes degradation in the performance of the battery 6 or deterioration of the battery 6. Thus, it can be said that it is not desirable to use the refrigerant in a dry ice state (arrow B1) for cooling in the second battery heat exchanger 6b.

Thus, in the one or more embodiments, the refrigerant in a relatively low enthalpy state that has been cooled in the cascade heat exchanger 2 is heated by heat exchange in the air conditioning heat exchanger 5a and the first battery heat exchanger 6a, and this refrigerant is supplied to the second battery heat exchanger 6b through the refrigerant passages 12, 13, 16, 17 (FIG. 2), thereby supplying the refrigerant that has been increased in specific enthalpy before being decompressed by the expansion valve E2 (arrow A2 in FIG. 5, point X2) to the second battery heat exchanger 6b. However, when the refrigerant having a too high specific enthalpy, specifically, the refrigerant in a largely superheated state (e.g., approximately 500 KJ/kg) is decompressed by the expansion valve E2 (arrow A3), although the refrigerant does not become a dry ice state, the temperature of the refrigerant becomes close to the temperature of the battery 6 (point X3). With the refrigerant in such a state (arrow B2), it is not possible to obtain sufficient cooling capability for the second battery heat exchanger 6b.

Thus, in the one or more embodiments, in addition to supplying the refrigerant that has passed through the air conditioning heat exchanger 5a and the first battery heat exchanger 6a to the second battery heat exchanger 6b as described above, the refrigerant that has not passed through the air conditioning heat exchanger 5a and the first battery heat exchanger 6a, specifically, the refrigerant in a relatively low enthalpy state that has been cooled in the cascade heat exchanger 2 is directly supplied to the second battery heat exchanger 6b from the refrigerant passage 14 that bypasses the refrigerant passages 12, 13 (FIG. 2). Accordingly, the refrigerant in a relatively low enthalpy state from the cascade heat exchanger 2 is mixed with the refrigerant that has become a relatively high enthalpy state in the air conditioning heat exchanger 5a and the first battery heat exchanger 6a (arrows A41, A42 in FIG. 5), and the refrigerant having an appropriate specific enthalpy (point X4) is supplied to the second battery heat exchanger 6b. As a result, when the refrigerant is decompressed by the expansion valve E2, it is possible to restrain the refrigerant from becoming a dry ice state (arrow A51), and ensure a temperature difference between the refrigerant and the battery 6 (arrow A52), thereby improving the cooling capability using the refrigerant in the second battery heat exchanger 6b.

More specifically, in the one or more embodiments, the control device 80 obtains the specific enthalpy of the refrigerant supplied to the second battery heat exchanger 6b, in particular, obtains the current specific enthalpy of the refrigerant at the confluence C2 of the refrigerant passage 14 and the refrigerant passage 16 (hereinbelow, referred to as the “C2 actual enthalpy”), and, when the C2 actual enthalpy exceeds a predetermined range, the control device 80 performs control to increase the opening degree of the flow control valve V3 provided on the refrigerant passage 14 that bypasses the refrigerant passages 12, 13 in order to increase the flow rate of the refrigerant in a relatively low enthalpy state. On the other hand, when the C2 actual enthalpy is below the predetermined range, the control device 80 performs control to reduce the opening degree of the flow control valve V3 in order to reduce the flow rate of the refrigerant in a relatively low enthalpy state. In this manner, the control device 80 adjusts the amount of the refrigerant in a relatively low enthalpy state from the cascade heat exchanger 2 that should be mixed with the refrigerant that has become a relatively high enthalpy state in the air conditioning heat exchanger 5a and the first battery heat exchanger 6a by controlling the opening degree of the flow control valve V3 on the refrigerant passage 14, thereby making the C2 actual enthalpy fall within the predetermined range.

This improves the cooling capability using the refrigerant in the second battery heat exchanger 6b while restraining the refrigerant in a dry ice state from being supplied to the second battery heat exchanger 6b. From such a viewpoint, the predetermined range applied to the C2 actual enthalpy used in the above-mentioned control is set to a range higher than a specific enthalpy at which the refrigerant becomes a dry ice state and is set on the basis of a specific enthalpy (e.g., 440 KJ/kg) at which a superheat degree defined by the saturated vapor line of the refrigerant is less than a predetermined value (preferably, around 0).

In addition, in the one or more embodiments, when the C2 actual enthalpy exceeds the predetermined range and the flow control valve V3 is in a fully open state, the control device 80 increases the opening degrees of the flow control valves V1, V2 provided on the refrigerant passages 12, 13 that are provided with the air conditioning heat exchanger 5a and the first battery heat exchanger 6a. In this case, since the refrigerant flow rate is insufficient for the cooling requirements of the air conditioner 5 and the battery 6, the opening degrees of the flow control valves V1, V2 are increased in order to increase the refrigerant flow rate in the air conditioning heat exchanger 5a and the first battery heat exchanger 6a. On the other hand, when the C2 actual enthalpy is below the predetermined range and the flow control valve V3 is in a fully closed state, the opening degrees of the flow control valves V1, V2 are reduced. In this case, since the refrigerant flow rate is excessive for the cooling requirements of the air conditioner 5 and battery 6, the opening degrees of the flow control valves V1, V2 are reduced in order to reduce the refrigerant flow rate in the air conditioning heat exchanger 5a and the first battery heat exchanger 6a.

Furthermore, in the one or more embodiments, when the C2 actual enthalpy exceeds the predetermined range and the flow control valves V1, V2, V3 are all in a fully open state, the control device 80 increases the discharge amount of the compressor 1. In this case, the cooling capability is improved by increasing the overall flow rate of the cooling system 100 (in particular, the first heat cycle circuit 100a).

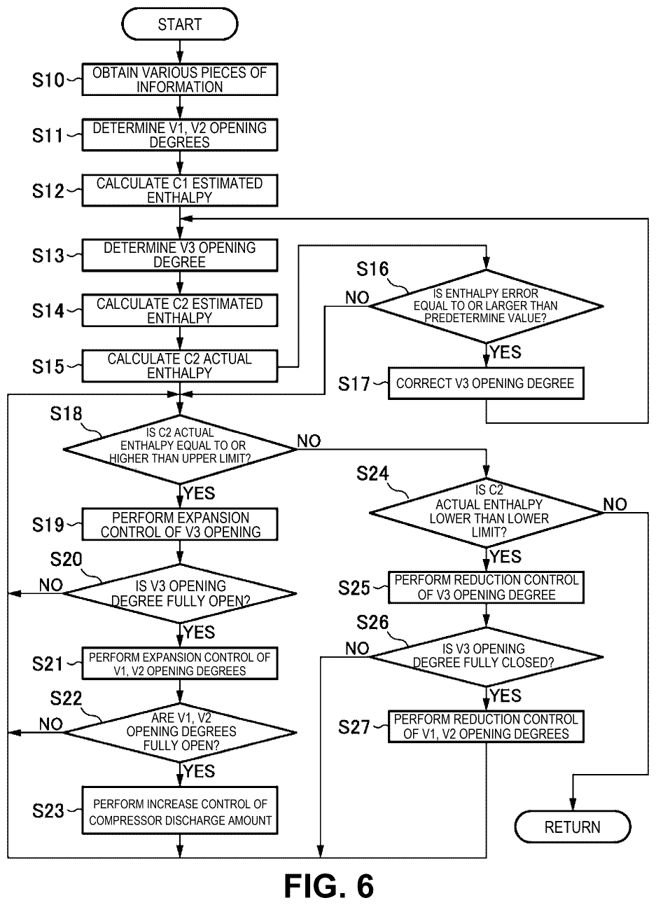

Next, a flowchart showing the specific control according to the one or more embodiments will be described with reference to FIG. 6. This flow is repeatedly executed by the control device 80 at a predetermined cycle. Specifically, the processor 80a in the control device 80 reads a program stored in the memory 80b and executes the program to implement the control related to this flow.

First, in step S10, the control device 80 obtains various pieces of information such as detection values detected by the sensors 41 to 44, 51 to 53, 71 to 73 (FIG. 4) described above.

Next, in step S11, the control device 80 determine the opening degrees of the flow control valves V1, V2 provided on the refrigerant passages 12, 13 that are provided with the air conditioning heat exchanger 5a and the first battery heat exchanger 6a (hereinbelow, referred to as the “V1 opening degree” and the “V2 opening degree” as appropriate) in accordance with the cooling requirements of the air conditioner 5 and the battery 6, respectively. In this case, the control device 80 determines the V1 opening degree and the V2 opening degree on the basis of the current temperature of the vehicle cabin detected by the vehicle cabin temperature sensor 71 and the current temperature of the battery 6 detected by the battery temperature sensor 72, in addition to the cooling requirements.

Next, in step S12, the control device 80 obtains the specific enthalpy of the refrigerant at the confluence C1 of the refrigerant passage 12, the refrigerant passage 13, and the refrigerant passage 16 (hereinbelow, referred to as the “C1 estimated enthalpy” as appropriate, note that the C1 estimated enthalpy corresponds to the specific enthalpy at point X2 in FIG. 5) on the basis of the V1 opening degree and the V2 opening degree determined in step S11, and the like. For example, the control device 80 obtains the C1 estimated enthalpy using a map, a calculation formula, or the like that is previously defined from the V1 opening degree, the V2 opening degree (may be the flow rate in the refrigerant passages 12, 13 corresponding to the V1 opening degree and the V2 opening degree), and the like.

Next, in step S13, the control device 80 determines the opening degree of the flow control valve V3 provided on the refrigerant passage 14 that bypasses the refrigerant passages 12, 13 (hereinbelow, referred to as the “V3 opening degree” as appropriate) to set the specific enthalpy of the refrigerant at the confluence C2 of the refrigerant passage 14 and the refrigerant passage 16 to the predetermined range described above on the basis of the C1 estimated enthalpy obtained in step S12. For example, the control device 80 obtains the flow rate from the refrigerant passage 14 that is required to set the specific enthalpy at the confluence C2 to the predetermined range on the basis of the C1 estimated enthalpy at the confluence C1, and determines the V3 opening degree that achieves this flow rate.

Next, in step S14, the control device 80 obtains the specific enthalpy of the refrigerant at the confluence C2 (hereinbelow, referred to as the “C2 estimated enthalpy” as appropriate. Note that the C2 estimated enthalpy corresponds to an estimated value of the specific enthalpy at point X4 in FIG. 5) on the basis of the V3 opening degree determined in step S13. That is, the control device 80 obtains the specific enthalpy at the confluence C2 (C2 estimated enthalpy) that is achieved by setting the flow control valve V3 to the V3 opening degree determined in step S13 using a map, a calculation formula, or the like that is previously defined.

Next, in step S15, the control device 80 obtains the C2 actual enthalpy (corresponding to an actual measured value of the specific enthalpy at point X4 in FIG. 5) on the basis of a pressure (corresponding to P1) detected by the refrigerant pressure sensor 51 that is provided on the refrigerant passage 11 downstream of the cascade heat exchanger 2 and a temperature detected by the refrigerant temperature sensor 42 that is provided at the confluence C2 (the temperature of the refrigerant supplied to the second battery heat exchanger 6b of the battery 6). Normally, the specific enthalpy can be obtained from pressure and temperature on the basis of the Mollier diagram that is previously determined.

Next, in step S16, the control device 80 determines whether the difference between the C2 estimated enthalpy obtained in step S14 and the C2 actual enthalpy obtained in step S15 (hereinbelow, referred to as the “enthalpy error” as appropriate) is equal to or larger than a predetermined value. As a result, when the enthalpy error is determined to be equal to or larger than the predetermined value (step S16: Yes), the control device 80 proceeds to step S17, corrects the V3 opening degree on the basis of the enthalpy error, and returns to step S13. In step S13, the control device 80 determines the V3 opening degree corrected in step S17 as the opening degree to be applied. On the other hand, when the enthalpy error is not determined to be equal to or larger than predetermined value (step S16: No), that is, when the enthalpy error is less than the predetermined value, the control device 80 proceeds to step S18 without performing the process of step S17 as described above.

Next, in step S18, the control device 80 determines whether the C2 actual enthalpy obtained in step S15 exceeds an upper limit of the predetermined range, that is, whether the C2 actual enthalpy is equal to or higher than an upper limit of the predetermined range. As a result, when the C2 actual enthalpy is determined to be equal to or higher than the upper limit (step S18: Yes), the control device 80 proceeds to step S19 and performs control (expansion control) to increase the V3 opening degree of the flow control valve V3 in order to increase the refrigerant in a relatively low enthalpy state that is supplied from the refrigerant passage 14.

Then, the control device 80 proceeds to step S20 and determines whether the V3 opening degree is fully open, that is, whether the V3 opening degree is already in a fully open state due to the expansion control of the flow control valve V3. As a result, when the V3 opening degree is determined to be fully open (step S20: Yes), the control device 80 proceeds to step S21 and performs control (expansion control) to increase the V1, V2 opening degrees of the flow control valves V1, V2. In this case, since the refrigerant flow rate is insufficient for the cooling requirements of the air conditioner 5 and the battery 6, the refrigerant flow rate in the air conditioning heat exchanger 5a and the first battery heat exchanger 6a is increased.

Then, the control device 80 proceeds to step S22, and determines whether the V1, V2 opening degrees are fully open, that is, whether the V1, V2 opening degrees are already in a fully open state due to the expansion control of the flow control valves V1, V2. As a result, when the V1, V2 opening degrees are determined to be fully open (step S22: Yes), the control device 80 proceeds to step S23 and performs control to increase the discharge amount of the compressor 1. In this case, the cooling capability is improved by increasing the flow rate of the entire system of the first heat cycle circuit 100a by increasing the discharge amount of the compressor 1. Then, the control device 80 returns to step S18 and performs the processes of step S18 and the subsequent steps again. Note that, before performing the determination of the C2 actual enthalpy in step S18, the control device 80 may obtain the C2 actual enthalpy again in the same procedure as in step S15 (the same applies hereinafter).

On the other hand, when the C2 actual enthalpy is not determined to be equal to or higher than the upper limit in step S18 (step S18: No), that is, when the C2 actual enthalpy is equal to or lower than the upper limit, the control device 80 proceeds to step S24. In addition, when the V3 opening degree is not determined to be fully open in step S20 (step S20: No), or when the V1, V2 opening degrees are not determined to be fully open in step S22 (step S22: No), the control device 80 returns to step S18.

Next, in step S24, the control device 80 determines whether the C2 actual enthalpy is below the predetermined range, that is, whether the C2 actual enthalpy is lower than a lower limit of the predetermined range. As a result, when the C2 actual enthalpy is determined to be lower than the lower limit (step S24: Yes), the control device 80 proceeds to step S25 and performs control (reduction control) to reduce the V3 opening degree of the flow control valve V3 in order to reduce the refrigerant in a relatively low enthalpy state that is supplied from the refrigerant passage 14.

Then, the control device 80 proceeds to step S26, and determines whether the V3 opening degree is fully closed, that is, whether the V3 opening degree is already in a fully closed state due to the reduction control of the flow control valve V3. As a result, when the V3 opening degree is determined to be fully closed (step S26: Yes), the control device 80 proceeds to step S27 and performs control (reduction control) to reduce the V1, V2 opening degrees of the flow control valves V1, V2. In this case, since the refrigerant flow rate is excessive for the cooling requirements of the air conditioner 5 and the battery 6, the refrigerant flow rate in the air conditioning heat exchanger 5a and the first battery heat exchanger 6a is reduced. Then, the control device 80 returns to step S18.

On the other hand, when the C2 actual enthalpy is not determined to be lower than the lower limit in step S24 (step S24: No), the control device 80 finishes the process shown in the flow of FIG. 6 because the C2 actual enthalpy is within the predetermined range in this case. In addition, when the V3 opening degree is not determined to be fully closed in step S26 (step S26: No), the control device 80 returns to step S18.

Note that, although the process is performed using the specific enthalpy in the flow described above, the process of the above flow may be performed using a superheat degree that is defined by the specific enthalpy and the saturated vapor line, instead of using the specific enthalpy.

### ACTION AND EFFECTS

Next, the action and effects of the cooling system 100 according to the one or more embodiments will be described. In the one or more embodiments, the cooling system 100 that performs cooling inside the vehicle 200 by circulating the refrigerant containing CO₂ (CO₂ refrigerant) includes the compressor 1 that compresses the refrigerant, the cascade heat exchanger 2 for cooling the refrigerant compressed by the compressor 1, the air conditioning heat exchanger 5a and the first battery heat exchanger 6a that use the refrigerant cooled by the cascade heat exchanger 2, the refrigerant passage 17 for supplying the refrigerant that has been used for cooling in the air conditioning heat exchanger 5a and the first battery heat exchanger 6a to the battery 6 to further cool the battery 6 using the refrigerant, the refrigerant passage 14 for supplying the refrigerant cooled by the cascade heat exchanger 2 to the refrigerant passage 17 without passing the refrigerant through the air conditioning heat exchanger 5a and the first battery heat exchanger 6a, the expansion valve E2 for expanding the refrigerant, the expansion valve E2 being provided on the refrigerant passage 17, the flow control valve V3 for adjusting the flow rate of the refrigerant, the flow control valve V3 being provided on the refrigerant passage 14, and the control device 80 configured to control at least the flow control valve V3, and the control device 80 obtains the specific enthalpy (C2 actual enthalpy) of the refrigerant supplied from the refrigerant passage 17 to the battery 6, and performs control to increase the opening degree of the flow control valve V3 when the specific enthalpy exceeds the predetermine range and performs control to reduce the opening degree of the flow control valve V3 when the specific enthalpy is below the predetermined range.

According to the one or more embodiments as described above, since the refrigerant in a relatively low enthalpy state from the cascade heat exchanger 2 is brought into a relatively high enthalpy state by heat exchange in the air conditioning heat exchanger 5a and the first battery heat exchanger 6a, and this refrigerant is supplied to the battery 6, it is possible to restrain the refrigerant in a dry ice state from being supplied to the battery 6. That is, it is possible to restrain the refrigerant supplied to the battery 6 from becoming a dry ice state due to the expansion (decompression) of the expansion valve E2 provided on the refrigerant passage 17. In addition, in the one or more embodiments, not only the refrigerant in a relatively high enthalpy state from the air conditioning heat exchanger 5a and the first battery heat exchanger 6a, but also the refrigerant in a relatively low enthalpy state from the cascade heat exchanger 2 that has not passed through the air conditioning heat exchanger 5a and the first battery heat exchanger 6a is supplied to the battery 6. In particular, in the one or more embodiments, by adjusting the amount of the refrigerant in a relatively low enthalpy state from the cascade heat exchanger 2 that is to be mixed with the refrigerant in a relatively high enthalpy state from the air conditioning heat exchanger 5a and the first battery heat exchanger 6a by controlling the opening degree of the flow control valve V3 on the refrigerant passage 14, the specific enthalpy of the refrigerant supplied to the battery 6 is maintained within the predetermined range. Accordingly, it is possible to supply the refrigerant having a relatively low temperature to the battery 6 and effectively cool the battery 6 using the refrigerant. From above, according to the one or more embodiments, it is possible to improve the cooling capability for the battery 6 using refrigerant while restraining the refrigerant in a dry ice state from being supplied to the battery 6.

In addition, according to the one or more embodiments, the cooling system 100 further includes the second battery heat exchanger 6b for directly cooling the plurality of cells 62 inside the battery 6 using the refrigerant by passing the refrigerant from the refrigerant passage 17 around the plurality of cells 62, and the second battery heat exchanger 6b is supplied with the refrigerant decompressed by the expansion valve E2. According to the one or more embodiments as described above, since the plurality of cells 62 are directly cooled using the refrigerant in the second battery heat exchanger 6b, it is possible to effectively cool the plurality of cells 62 of the battery 6. In this case, since it is not desirable to supply the high-pressure refrigerant from the compressor 1 as it is to the second battery heat exchanger 6b because the pressure resistance of the battery pack 61 and the like is relatively low, the refrigerant from the compressor 1 is decompressed by the expansion valve E2 and supplied to the second battery heat exchanger 6b in the one or more embodiments. Accordingly, it is possible to properly protect the inside of the battery 6 (such as the plurality of cells 62).

In addition, according to the one or more embodiments, the cooling system 100 further includes the flow control valves V1, V2 for adjusting the flow rate of the refrigerant supplied to the air conditioning heat exchanger 5a and the first battery heat exchanger 6a, and the control device 80 performs control to increase the opening degrees of the flow control valves V1, V2 when the specific enthalpy of the refrigerant exceeds the predetermined range and the flow control valve V3 is fully open, and performs control to reduce the opening degrees of the flow control valves V1, V2 when the specific enthalpy of the refrigerant is below the predetermined range and the flow control valve V3 is fully closed. Accordingly, when the flow control valve V3 is already in a fully open state, since the refrigerant flow rate is insufficient for the cooling requirements in the cooling system 100, it is possible to increase the refrigerant flow rate by increasing the opening degrees of the flow control valves V1, V2, and when the flow control valve V3 is already in a fully closed state, since the refrigerant flow rate is excessive for the cooling requirements in the cooling system 100, it is possible to reduce the refrigerant flow rate by reducing the opening degrees of the flow control valves V1, V2.

In addition, according to the one or more embodiments, the predetermined range described above is set to the range higher than the specific enthalpy at which the refrigerant containing CO₂ becomes a dry ice state. By controlling the flow control valve V3 using such a predetermined range, it is possible to reliably restrain the refrigerant in a dry ice state from being supplied to the battery 6.

In addition, according to the one or more embodiments, the predetermined range described above is set on the basis of the specific enthalpy at which the superheat degree defined by the saturated vapor line of the refrigerant is less than the predetermined value. Accordingly, it is possible to supply the refrigerant having a relatively small superheat degree (that is, the refrigerant having a relatively low temperature that is not in a dry ice state) to the battery 6 and effectively improve the cooling capability for the battery 6 using refrigerant.

In addition, according to the one or more embodiments, the cooling system 100 further includes the refrigerant pressure sensor 51 that detects the pressure of the refrigerant from the cascade heat exchanger 2, and the refrigerant temperature sensor 42 that detects the temperature of the refrigerant inside the refrigerant passage 17, and the control device 80 obtains the specific enthalpy from the pressure and the temperature respectively detected by the refrigerant pressure sensor 51 and the refrigerant temperature sensor 42. By using the pressure and the temperature of the refrigerant detected by the sensors in this manner, it is possible to accurately obtain the specific enthalpy of the refrigerant.

In addition, according to the one or more embodiments, as the heat exchanger that uses the refrigerant cooled by the cascade heat exchanger 2, the air conditioning heat exchanger 5a for performing air conditioning of the vehicle 200, and the first battery heat exchanger 6a that indirectly cools the plurality of cells 62 using the refrigerant by supplying the refrigerant to the outside of the battery pack 61 including the plurality of cells 62 in the battery 6 are used. According to the one or more embodiments as described above, it is possible to appropriately achieve both air conditioning of the vehicle 200 and cooling of the battery 6 using the refrigerant circulated in the cooling system 100. In particular, by using the first battery heat exchanger 6a that indirectly cools the plurality of cells 62 by supplying the refrigerant to the outside of the battery pack 61, it is possible to achieve relatively large heat exchange with the refrigerant.

In addition, according to the one or more embodiments, the cascade heat exchanger 2 is configured to perform heat exchange between the first heat cycle circuit 100a including the compressor 1, the air conditioning heat exchanger 5a, the first battery heat exchanger 6a, and the like and the second heat cycle circuit 100b including the outside air heat exchanger 30 that exchanges heat with the outside air separately from the first heat cycle circuit 100a. Accordingly, by causing the first heat cycle circuit 100a to perform heat exchange (cascade heat exchange) with the second heat cycle circuit 100b that exchanges heat with the outside air, it is possible to improve the efficiency of the entire system of the first heat cycle circuit 100a, in other words, reduce the work of the compressor 1.

In addition, according to the one or more embodiments, the cooling system 100 further cools, using the refrigerant cooled by the cascade heat exchanger 2, the motor 4 that drives the vehicle 200 using electric power of the battery 6. Accordingly, it is possible to appropriately achieve cooling of various components inside the vehicle 200, such as the motor 4, using the refrigerant circulated in the cooling system 100.

### Modifications

Although, in the embodiment described above, the cooling system 100 includes the first heat cycle circuit 100a and the second heat cycle circuit 100b, in another example, the cooling system 100 may include only the first heat cycle circuit 100a. In that case, the cascade heat exchanger 2 may be configured as the outside air heat exchanger. Note that, when the cooling system 100 includes the first heat cycle circuit 100a and the second heat cycle circuit 100b, although the system efficiency becomes high (that is, the work of the compressor 1 can be reduced), the configuration becomes complicated. Thus, when simplification of the configuration is prioritized over the system efficiency, the cooling system 100 preferably includes only the first heat cycle circuit 100a.

In addition, although, in the embodiment described above, the temperature of the battery 6 is detected by the battery temperature sensor 72, in another example, the temperature of the battery 6 may be estimated in accordance with the current value or the voltage value of the battery 6, the output requirements of the battery 6, the charging speed requirements of the battery 6, or the like. In still another example, the temperature of the battery 6 may be estimated on the basis of the temperature of the refrigerant detected by the refrigerant temperature sensor 44 that is provided on the refrigerant passage 17 downstream of the second battery heat exchanger 6b.

### REFERENCE SIGNS LIST

1 compressor
1a first compressor
1b second compressor
2 heat exchanger (cascade heat exchanger)
4 motor
5 air conditioner
5a air conditioning heat exchanger
6 battery
6a first battery heat exchanger
6b second battery heat exchanger
11 to 20 refrigerant passage
41, 42, 43, 44 refrigerant temperature sensor
51, 52, 53 refrigerant pressure sensor
61 battery pack
62 cell
80 control device
100 cooling system
100a first heat cycle circuit
100b second heat cycle circuit
200 vehicle
E1, E2, E3 expansion valve
V1, V2, V3 flow control valve

1. A cooling system that performs cooling inside a vehicle by circulating a refrigerant, the cooling system, comprising:
a compressor that compresses the refrigerant, the refrigerant containing CO₂;
a first heat exchanger for cooling the refrigerant compressed by the compressor;
a second heat exchanger for cooling a predetermined cooling target inside the vehicle using the refrigerant cooled by the first heat exchanger;
a first refrigerant passage for supplying the refrigerant that has been used for cooling in the second heat exchanger to a battery inside the vehicle to further cool the battery using the refrigerant;
a second refrigerant passage for supplying the refrigerant cooled by the first heat exchanger to the first refrigerant passage without passing the refrigerant through the second heat exchanger;
an expansion valve for expanding the refrigerant, the expansion valve being provided on the first refrigerant passage;
a flow control valve for adjusting a flow rate of the refrigerant, the flow control valve being provided on the second refrigerant passage; and
processing circuitry configured to:
obtain an enthalpy of the refrigerant supplied from the first refrigerant passage to the battery, and
perform control to increase an opening degree of the flow control valve when the enthalpy exceeds a predetermine range and perform control to reduce the opening degree of the flow control valve when the enthalpy is below the predetermined range.

2. The cooling system according to claim 1, further comprising a battery heat exchanger for directly cooling a plurality of cells inside the battery using the refrigerant by passing the refrigerant from the first refrigerant passage around the plurality of cells, wherein
the battery heat exchanger is supplied with the refrigerant decompressed by the expansion valve.

3. The cooling system according to claim 1, wherein the flow control valve is defined as a first flow control valve,
the cooling system further includes a second flow control valve for adjusting a flow rate of the refrigerant supplied to the second heat exchanger, and
the processing circuitry is further configured to:
perform control to increase an opening degree of the second flow control valve when the enthalpy exceeds the predetermined range and the first flow control valve is fully open, and
perform control to reduce the opening degree of the second flow control valve when the enthalpy is below the predetermined range and the first flow control valve is fully closed.

4. The cooling system according to claim 2, wherein the flow control valve is defined as a first flow control valve,
the cooling system further comprises a second flow control valve for adjusting a flow rate of the refrigerant supplied to the second heat exchanger, and
the processing circuitry is further configured to:
perform control to increase an opening degree of the second flow control valve when the enthalpy exceeds the predetermined range and the first flow control valve is fully open, and
perform control to reduce the opening degree of the second flow control valve when the enthalpy is below the predetermined range and the first flow control valve is fully closed.

5. The cooling system according to claim 1, wherein the predetermined range is set higher than an enthalpy at which the refrigerant containing CO₂ becomes a dry ice state.

6. The cooling system according to claim 2, wherein the predetermined range is set higher than an enthalpy at which the refrigerant containing CO₂ becomes a dry ice state.

7. The cooling system according to claim 1, wherein the predetermined range is set on the basis of an enthalpy at which a superheat degree defined by a saturated vapor line of the refrigerant is less than a predetermined value.

8. The cooling system according to claim 2, wherein the predetermined range is set on the basis of an enthalpy at which a superheat degree defined by a saturated vapor line of the refrigerant is less than a predetermined value.

9. The cooling system according to claim 1, further comprising:
a refrigerant pressure sensor that detects a pressure of the refrigerant from the first heat exchanger; and
a refrigerant temperature sensor that detects a temperature of the refrigerant inside the first refrigerant passage, wherein
the processing circuitry is further configured to obtain the enthalpy from the pressure and the temperature respectively detected by the refrigerant pressure sensor and the refrigerant temperature sensor.

10. The cooling system according to claim 2, further comprising:
a refrigerant pressure sensor that detects a pressure of the refrigerant from the first heat exchanger; and
a refrigerant temperature sensor that detects a temperature of the refrigerant inside the first refrigerant passage, wherein
the processing circuitry is further configured to obtain the enthalpy from the pressure and the temperature respectively detected by the refrigerant pressure sensor and the refrigerant temperature sensor.

11. The cooling system according to claim 1, wherein the second heat exchanger includes an air conditioning heat exchanger for performing air conditioning of the vehicle and/or a battery heat exchanger for indirectly cooling a plurality of cells of the battery using the refrigerant by supplying the refrigerant to outside of the battery.

12. The cooling system according to claim 2, wherein the second heat exchanger includes an air conditioning heat exchanger for performing air conditioning of the vehicle and/or a battery heat exchanger for indirectly cooling a plurality of cells of the battery using the refrigerant by supplying the refrigerant to outside of the battery.

13. The cooling system according to claim 1, wherein the first heat exchanger is a cascade heat exchanger that performs heat exchange between a first heat cycle circuit and a second heat cycle circuit,
the first heat cycle circuit includes at least the compressor, the second heat exchanger, the first refrigerant passage, the second refrigerant passage, the expansion valve, and the flow control valve, and
the second heat cycle circuit includes an outside air heat exchanger that exchanges heat with outside air separately from the first heat cycle circuit.

14. The cooling system according to claim 2, wherein the first heat exchanger is a cascade heat exchanger that performs heat exchange between a first heat cycle circuit and a second heat cycle circuit,
the first heat cycle circuit includes at least the compressor, the second heat exchanger, the first refrigerant passage, the second refrigerant passage, the expansion valve, and the flow control valve, and
the second heat cycle circuit includes an outside air heat exchanger that exchanges heat with outside air separately from the first heat cycle circuit.

15. The cooling system according to claim 1, wherein the cooling system is configured to further cool, using the refrigerant cooled by the first heat exchanger, a motor that drives the vehicle using electric power of the battery.

16. The cooling system according to claim 2, wherein the cooling system is configured to further cool, using the refrigerant cooled by the first heat exchanger, a motor that drives the vehicle using electric power of the battery.

17. A vehicle including:
a battery;
a motor that drives the vehicle using electric power of the battery; and
a cooling system that performs cooling inside the vehicle by circulating a refrigerant containing CO₂, the cooling system comprising:
a compressor that compresses the refrigerant, the refrigerant containing CO₂;
a first heat exchanger for cooling the refrigerant compressed by the compressor;
a second heat exchanger for cooling a predetermined cooling target inside the vehicle using the refrigerant cooled by the first heat exchanger;
a first refrigerant passage for supplying the refrigerant that has been used for cooling in the second heat exchanger to the battery inside the vehicle to further cool the battery using the refrigerant;
a second refrigerant passage for supplying the refrigerant cooled by the first heat exchanger to the first refrigerant passage without passing the refrigerant through the second heat exchanger;
an expansion valve for expanding the refrigerant, the expansion valve being provided on the first refrigerant passage;
a flow control valve for adjusting a flow rate of the refrigerant, the flow control valve being provided on the second refrigerant passage; and
processing circuitry configured to:
obtain an enthalpy of the refrigerant supplied from the first refrigerant passage to the battery, and
perform control to increase an opening degree of the flow control valve when the enthalpy exceeds a predetermine range and perform control to reduce the opening degree of the flow control valve when the enthalpy is below the predetermined range.

18. The vehicle according to claim 17, further comprising a battery heat exchanger for directly cooling a plurality of cells inside the battery using the refrigerant by passing the refrigerant from the first refrigerant passage around the plurality of cells, wherein
the battery heat exchanger is supplied with the refrigerant decompressed by the expansion valve.

19. The vehicle according to claim 17, wherein the flow control valve is defined as a first flow control valve,
the cooling system further comprises a second flow control valve for adjusting a flow rate of the refrigerant supplied to the second heat exchanger, and
the processing circuitry is further configured to:
perform control to increase an opening degree of the second flow control valve when the enthalpy exceeds the predetermined range and the first flow control valve is fully open, and
perform control to reduce the opening degree of the second flow control valve when the enthalpy is below the predetermined range and the first flow control valve is fully closed.

20. A method for performing cooling of a vehicle, comprising:
compressing, by a compressor, a refrigerant containing CO₂;
cooling, by a first heat exchanger, the refrigerant compressed by the compressor;
cooling the vehicle, by a second heat exchanger, a predetermined cooling target inside the vehicle, using the refrigerant cooled by the first heat exchanger;
supplying, by a first refrigerant passage, the refrigerant that has been used for cooling in the second heat exchanger to a battery inside the vehicle to further cool the battery using the refrigerant;
supplying, by a second refrigerant passage, the refrigerant cooled by the first heat exchanger to the first refrigerant passage without passing the refrigerant through the second heat exchanger;
expanding, by an expansion valve, the refrigerant, the expansion valve being provided on the first refrigerant passage;
adjusting, by a flow control valve, a flow rate of the refrigerant, the flow control valve being provided on the second refrigerant passage; and
by processing circuitry:
obtaining an enthalpy of the refrigerant supplied from the first refrigerant passage to the battery; and
performing control to increase an opening degree of the flow control valve when the enthalpy exceeds a predetermine range and perform control to reduce the opening degree of the flow control valve when the enthalpy is below the predetermined range.
